(19) United States
(12) Patent Application Publication
(10) Pub. No.: US 2010/0083034 A1
(43) Pub. Date: Apr. 1, 2010

(54) INFORMATION PROCESSING APPARATUS AND CONFIGURATION CONTROL METHOD

(75) Inventor: Takayuki TAMURA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/565,977

(22) Filed: Sep. 24, 2009

(30) Foreign Application Priority Data
Oct. 1, 2008 (JP) 2008-255914

(51) Int. Cl. G06F 11/20; G06F 9/50

(52) U.S. Cl. 714/4; 718/104; 718/103; 714/E11.071

(57) ABSTRACT

An information processing apparatus for providing a plurality of services by a plurality of software programs, includes: a plurality of hardware resources; a storage unit that stores priorities of the services; a processor that controls configuration of the hardware resources in accordance with a process including: partitioning the plurality of hardware resources into a plurality of groups each of which executes each of the software programs; determining, upon detecting a failure in at least one of the hardware resources in at least one of the groups, another hardware resource which belongs to another group for executing another software programs on the basis of the priorities of services provided by the software programs in reference to the storage unit; and assigning the another hardware resource to the group which includes the one of the hardware resources having the failure so as to renew configuration of the hardware resources.

### CROSS-REFERENCE TO RELATED APPLICATION

This application is based upon and claims the benefit of priority of the prior Japanese Patent Application No. 2008-255914, filed on Oct. 1, 2008, the entire contents of which are incorporated herein by reference.

### FIELD

A certain aspect of the embodiments discussed herein is related to information processing apparatuses and control methods.

### BACKGROUND

As a specific example of an information processing apparatus including a plurality of partitions therein, PRIMEQUEST™, which is a server in a mission critical (MC) field, or the like, can be suggested. An information processing apparatus 10, depicted in FIG. 18, is constituted by system boards (SBs) 111 each having a central processing unit (CPU) and memory, input/output units (IOUs) 112 each including hard disk drives (HDDs), peripheral component interconnect (PCI) card slots and the like mounted therein, crossbars 113 configured to provide connections between SBs 111 and IOUs 112, and management boards (MMBs) 114.

As depicted in FIG. 18, the information processing apparatus 10 enables the SBs 111 and the IOUs 112, each being a hardware resource, to be reconfigured via the crossbars 113, that is, allows one or a plurality of the SBs 111 and one or a plurality of the IOUs 112 to be configured as one of logical partitions 20 in accordance with control performed by one of the MMBs 114. Each of the partitions 20 is information processing means including hardware resources, such as SBs 111 and IOUs 112. A maximum number of partitions which can be provided in a chassis is, for example, sixteen, and various jobs corresponding to individual partitions 20 can be achieved. With respect to management of this information processing apparatus 10, for example, a system administrator uses management software, which is so-called web user interface (Web-UI) and is one of pieces of firmware incorporated in the MMBs, and thereby, performs fault surveillance and system setting operations of hardware resources (MMBs 114, SBs 111, IOUs 112 and the like) included in the equipment frame of the information processing apparatus 10, further, fault surveillance and power related operation of the partitions 20, and setting (for example, addition or deletion) of the partitions 20.

A process flow commencing from the occurrence of a fault and terminating at the recovery thereof, which is executed by the information processing apparatus 10 which has been described with reference to FIG. 18, will be described in the following (1) to (10).

(1) A fault occurs in one of hardware resources.

(2) A user of the information processing apparatus 10 notifies a system administrator's device, which is a processing device for system administrators, of the fault occurring in the hardware resource, by means of e-mail, displaying the fault on a screen thereof, or the like.

(3) The user identifies a fault point by using the MMB Web-UI.

(4) The user selects a hardware resource targeted for replacement from among unused hardware resources. The hardware resource targeted for replacement is a hardware resource with which the faulty hardware resource is to be replaced.

(5-A) In the case where there is no hardware unused resource, the user determines whether the hardware resource targeted for replacement can be allocated from among other partitions, or not, by receiving advice from the system administrator.

(5-B) In the case where there is an unused hardware resource targeted for replacement, the user recoveries the system by executing the following steps (6) to (10).

(6) The user turns off a power supplied to a targeted partition by using the MMB Web-UI. The targeted partition is a partition including a hardware resource of the same type as the faulty hardware resource.

(7) The user performs saving of the faulty hardware resource.

(8) The user incorporates the resource targeted for replacement and replaces the foregoing faulty hardware resource therewith.

(9) The user turns on a power supplied to the targeted partition by using the MMB Web-UI.

(10) The user confirms that the targeted partition is properly operating by using the MMB Web-UI.

In addition, a service recovery system has been proposed that suggests that, a resource related condition with respect to a service which had been provided by a machine experiencing a fault is read out, and on the basis of this read-out resource condition, and load information associated with individual machines not experiencing a fault, a different machine which is caused to execute the service, which had been provided by the faulty machine, in substitution therefore is determined. Above technology is disclosed in Japanese Laid-open Patent Publication No. 2001-155003.

In an information processing apparatus including a plurality of partitions, such as the information processing apparatus 10, which has been described above with reference to FIG. 18, when a fault occurs in one of hardware resources included in a partition, as described in the foregoing (5-A), in the case where there is no unused resource, a user determines whether a resource targeted for replacement can be allocated from among other partitions, or not, by receiving advice from system administrators. Therefore, it is impossible to promptly perform system recovery of the faulty partition. Further, even in the case where there is an unused resource, it is preferable for the user to manually execute the steps (6) to (10) described above, thus causing a large amount of time while the system is halted.

### SUMMARY

According to an aspect of an embodiment, an information processing apparatus for providing a plurality of services by a plurality of software programs, includes: a plurality of hardware resources; a storage unit that stores priorities of the services; a processor that controls configuration of the hardware resources in accordance with a process including: partitioning the plurality of hardware resources into a plurality of groups each of which executes each of the software programs; determining, upon detecting a failure in at least one of the hardware resources in at least one of the groups, another hardware resource which belongs to another group for executing another software programs on the basis of the priorities of services provided by the software programs in reference to the storage unit; and assigning the another hardware resource to the group which includes the one of the hardware resources having the failure so as to renew configuration of the hardware resources.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a configuration of an information processing apparatus according to an embodiment.

FIG. 2 is a diagram illustrating an example of a configuration of a configuration managing section according to an embodiment.

FIG. 3 is a diagram illustrating an example of a block of point setting information set in a point setting information DB according to an embodiment.

FIG. 4 is a diagram illustrating an example of allocation of point value related information according to an embodiment.

FIG. 5 is a diagram illustrating an example of priorities corresponding to respective partitions according to an embodiment.

FIG. 6 is time transitions of priorities for weekdays with respect to respective partitions according to an embodiment.

FIG. 7 is time transitions of priorities for Saturday with respect to respective partitions according to an embodiment.

FIG. 8 is a diagram illustrating an example of a flow of the processes of setting point setting information in a setting information DB according to an embodiment.

FIG. 9 is a diagram illustrating an example of a flow of the processes of performing control of reconfiguration of resources of an apparatus according to an embodiment.

FIG. 10 is an example of a control method of reconfiguration of resources of an apparatus according to an embodiment.

FIG. 11 is information related to priorities of partitions according to an embodiment.

FIG. 12 is an explaining diagram of a first example of a control method of reconfiguration of resources of an apparatus according to an embodiment.

FIG. 13 is an explaining diagram of a first example of a control method of reconfiguration of resources of an apparatus according to an embodiment.

FIG. 14 is an explaining diagram of a second example of a control method of reconfiguration of resources of an apparatus according to an embodiment.

FIG. 15 is an explaining diagram of a second example of a control method of reconfiguration of resources of an apparatus according to an embodiment.

FIG. 16 is an explaining diagram of a second example of a control method of reconfiguration of resources of an apparatus according to an embodiment.

FIG. 17 is an explaining diagram of a second example of a control method of reconfiguration of resources of an apparatus according to an embodiment.

FIG. 18 is a configuration example of an information processing apparatus.

### DESCRIPTION OF THE EMBODIMENTS

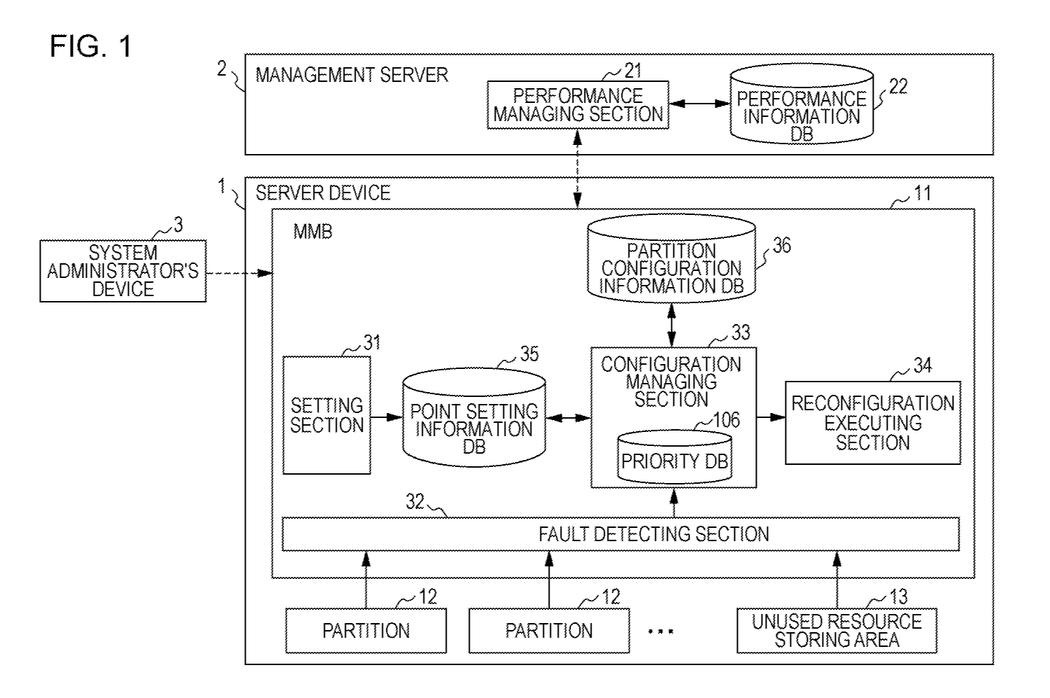

FIG. 1 is a diagram illustrating a configuration of an information processing apparatus according to an embodiment of the present invention. In FIG. 1, explanation will be made by way of an example in which an information processing apparatus according to this embodiment includes a server device 1 and a management server 2. In addition, a system administrator's device 3 depicted in FIG. 1 is a computer device used by system administrators, and is configured to be capable of communicating with the server device 1. The information processing apparatus according to this embodiment may be configured so that the management server 2 is omitted therefrom.

The server apparatus 1 includes a management board (MMB) 11, a plurality of partitions 12, and an unused resource storing area 13. The MMB 11 is a service processor (SVP), i.e., a system control device, configured to include a function of control means for performing control of reconfiguration of the partitions 12. Each of the partitions 12 is information processing means including hardware resources, such as SBs and IOUs, and is configured to be capable of performing information processing by using these hardware resources. The foregoing SB includes, for example, a CPU, memory and the like, and the foregoing IOU includes, for example, HDDs and the like. The unused resource storing area is an area in which unused resources are stored.

The MMB 11 includes a setting section 31, a fault detecting section 32, a configuration managing section 33, a reconfiguration executing section 34, a point setting information DB 35, and a partition configuration information DB 36. The setting section 31 sets a block of point setting information for each of the partitions, which has been inputted to the server device 1 by the system administrator's device 3, in the point setting information DB 35. The block of point setting information for each of the partitions 12 is a block of information which includes, for example, point values, each being allocated in advance to a piece of software operating in the partition 12, and representing a degree of importance with respect to the piece of software (a degree of necessity of operation with respect to the piece of software), further, performance utilization necessity/non-necessity information, and alarm notification necessity/non-necessity information. The performance utilization necessity/non-necessity information is a piece of information, being managed by the management server 2, and representing whether reconfiguration of hardware resources of the partition 12 by utilizing performance information, which will be described below, is to be performed, or not. The alarm notification necessity/non-necessity information is a piece of information, representing whether the system administration's device 3 is to be notified of an alarm indicating that a fault has occurred in a hardware resource included in the partition 12, or not. In addition, handling may be performed so that one of the foregoing point values representing degrees of importance with respect to the corresponding pieces of software is allocated to the corresponding piece of software in advance as a piece of point setting information for either each time slot within a day, each day of the week, or each time slot within each day of the week.

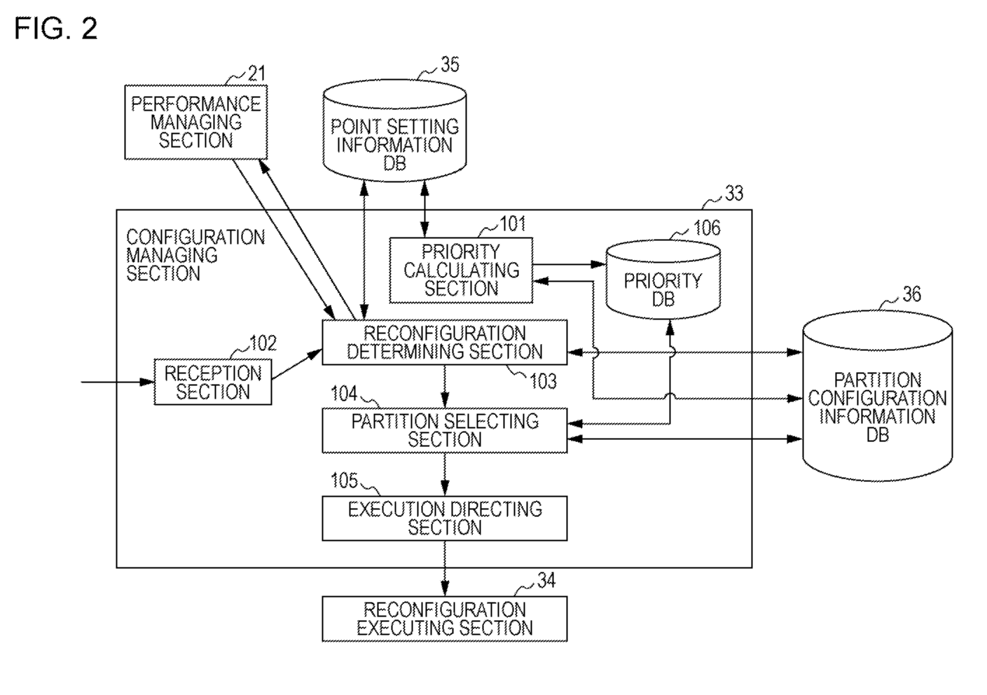

The fault detecting section 32 detects that a fault has occurred in a hardware resource included in one of the partitions 12, and notifies a reception section 102 (refer to FIG. 2) of the occurrence of the fault.

Upon receipt of a notification from the fault detecting section 32 which indicates that a fault has occurred in a hardware resource included in one of the partitions 12, on the basis of priorities stored in the priority DB 106, the configuration managing section 33 selects one of the partitions 12, which is a target for reconfiguration, as a selected partition. The foregoing priorities are ones, corresponding to the partitions 12, respectively, and representing orders in which the configurations of the corresponding partitions are sustained. On the basis of the point setting information, which is set in the point setting information DB 35, and partition configuration information, which is stored in the partition configuration information DB 36 in advance, the configuration managing section 33 calculates priorities corresponding to respective partitions 12, and stores the resultant priorities in the priority DB 106. The configuration managing section 33 continuously or regularly calculates the priorities and updates the priorities stored in the priority DB 106 by using the calculated priorities. The partition configuration information includes at least information related to hardware resources included in respective partitions 12 and information related to pieces of software operating or being installed in respective partitions 12. The foregoing information related to hardware resources includes, for example, information related to the SBs and the IOUs included in each of the partitions 12, information related to the CPU and the memory included in each of the SBs, and information related to the HDDs included in each of the IOUs.

Moreover, the configuration managing section 33 directs the reconfiguration executing section 34 to execute reconfiguration of the partitions 12. More specifically, the configuration managing section 33 directs the reconfiguration executing section 34 to replace the foregoing faulty hardware resource with a hardware resource included in the foregoing selected partition.

Upon occurrence of a fault in a hardware resource, processing may be performed so that the configuration managing section 33 transmits a request for acquisition of performance information, which will be described below, to the management server 2, and on the basis of performance information transmitted from the management server 2 in response to the request for acquisition, the configuration managing section 33 determines whether the reconfiguration of the partition 12 including the faulty hardware resource is to be executed, or not. Further, in the case where the configuration managing section 33 determines that the reconfiguration of the partitions 12 is to be executed, processing may be performed so that a selected partition is selected on the basis of priorities stored in the priority DB 106 as of then.

In accordance with a direction from the configuration managing section 33, the reconfiguration executing section 34 executes reconfiguration of the partition 2 by replacing the hardware resource experiencing the fault with a hardware resource included in the selected partition. In the point setting information DB 35, the foregoing point setting information is set. In the partition configuration information DB 36, the foregoing partition configuration information is stored in advance. In addition, processing may be performed so that the reconfiguration executing section 34 executes reconfiguration of the partition 12 in accordance with a direction from the system administrator's device 3.

The management server 2 is a management device configured to manage performance information related to hardware resources included in respective partitions 12 inside the server device 1. More specifically, the performance managing section 21 included in the management server 2 continuously or regularly collects information related to usage rates of the CPU and the memory included in each of the partitions 12 inside the server device 1 as pieces of performance information, and stores the collected pieces of performance information in the performance information DB 22. Further, upon receipt of a request for performance information from the performance managing section 33 inside the server device 1, the performance management section 21 transmits the requested performance information to the performance managing section 33. The system administrator's device 3 causes the point setting information to be entered in accordance with commands inputted by system administrators, and directs the setting section 31 inside the server device 1 to set this entered point setting information into the point setting information DB 35. In addition, processing may be performed so that the system administrator's device 3 directs the reconfiguration executing section 34 inside the server device 1 to execute reconfiguration of the partition 12.

FIG. 2 is a diagram illustrating an example of a configuration of a configuration managing section. The configuration managing section 33 includes a priority calculating section 101, a reception section 102, a reconfiguration determining section 103, a partition selecting section 104, an execution directing section 105, and a priority DB 106. On the basis of the point setting information, which is set in the point setting information DB 35, and partition configuration information, which is stored in advance in the partition configuration information DB 36, the priority calculating section 101 calculates priorities corresponding to respective partitions 12, and stores the resultant priorities in the priority DB 106. The priority calculating section 101 constantly or regularly calculates the priorities and updates the priorities stored in the priority DB 106 by using the calculated priorities.

For example, by referring to the partition configuration information DB 36, the priority calculating section 101 recognizes pieces of software operating in each of the partitions 12. Further, the priority calculating section 101 calculates the sum total of point values representing degrees of importance with respect to pieces of software operating in the partition 12, the point values being included in the setting information, so that the calculated sum total of the point values represents a priority corresponding to the partition 12. In addition, processing may be performed so that, in the case where certain groups of the foregoing point values representing degrees of importance with respect to the corresponding pieces of software are included in the point setting information, each of the groups corresponding to one of pieces of software operating in the partition 12 and including the point values corresponding to either time slots within a day, days of the week, or time slots within individual days of the week, respectively, the priority calculating section 101 calculates the sum total of the point values with respect to pieces software operating in the partition 12 during either the present time slot within a day, the present day of the week, or the present time slot within the present day of the week so that the calculated sum total of the point values represents a priority with respect to either the present time slot within a day, the present day of the week, or the present time slot within the present day of the week, which corresponds to the partition 12 in which the pieces of software are operating. Therefore, upon occurrence of a fault in a hardware resource, the priority calculating section 101 calculates the sum total of point values with respect to pieces of software operating in each of the partitions 12 during either a time slot within a day, a day of the week, or a time slot within a day of the week when the fault has occurred in the hardware resource so that the calculated total sum of the point values represents a priority corresponding to the partition 12 in which the pieces of software are operating.

The reception section 102 receives a notification indicating that a fault has occurred in a hardware resource inside one of the partitions 12 from the fault detecting section 32 (refer to FIG. 1), and notifies the reconfiguration determining section 103 of the received content. Upon receipt of the foregoing notification from the reception section 102, the reconfiguration determining section 103 refers to the foregoing performance utilization necessity/non-necessity information included in point setting information stored in the point setting information DB 35, and thereby, makes a decision as to whether the necessity/non-necessity of reconfiguration of hardware resources of the partition 2 by using the performance information is to be determined, or not. In the case where the reconfiguration determining section 103 has made a decision that the necessity/non-necessity of reconfiguration of hardware resources of the partition 2 by using the performance information is not to be determined, the partition selecting section 104 executes a process of selecting a partition to be selected. In the case where the reconfiguration determining section 103 has made a decision that the necessity/non-necessity of reconfiguration of hardware resources of the partition 2 by using the performance information is to be determined, the reconfiguration determining section 103 transmits a request for acquisition of performance information related to the foregoing partition 12 including the faulty hardware resource (which will be termed “a target partition” in the following description) to the performance managing section 21 of the management server 2, and thereby, acquires this performance information from the performance managing section 21. Further, the reconfiguration determining section 103 acquires configuration information related to the target partition from the partition configuration information DB 36, and determines whether reconfiguration of hardware resources of the target partition is to be performed, or not, on the basis of the acquired configuration information and the performance information. More specifically, the reconfiguration determining section 103 determines whether processes, which are consistent with a usage rate resulting from processes performed by hardware resources included in the target partition before the hardware resource experienced the fault, can be achieved by the other hardware resources not experiencing a fault, which are included in the same target partition, or not, and in the case where the determination result is that the other hardware resources not experiencing a fault are not capable of achieving the foregoing processes consistent with the usage rate resulting from the processes performed by the hardware resources, it is determined that the reconfiguration of the target partition is to be performed. In contrast, in the case where the determination result is that the other hardware resources not experiencing a fault are capable of achieving the foregoing processes consistent with the usage rate resulting from processes performed by the hardware resources, it is determined that the reconfiguration of the target partition is not to be performed.

For example, it is assumed that one hardware resource out of hardware resources, such as CPUs, included in a target partition experiences a fault. In the case where, according to configuration information related to the target partition, three hardware resources are included in the target partition, and further, according to performance information, a total usage rate resulting from processes performed by these three hardware resources is 210%, once one hardware resource experiences a fault, a usage rate on average per one hardware resource out of two remaining hardware resources is 105%, and as a result, since the usage rate is more than 100%, the two remaining hardware resources are not capable of achieving processes which are consistent with the usage rate (210%) as of before the fault occurred. Therefore, the reconfiguration determining section 103 determines to perform reconfiguration of hardware resources of the target partition, and directs the partition selecting section 104 to execute a selection process of selecting a partition to be selected. In contrast, in the case where, according to performance information, a total usage rate resulting from processes performed by these three hardware resources is 180%, a usage rate on average per one hardware out of the two remaining hardware resources is 90%, and since the usage rate is less than 100%, the two remaining hardware resources are capable of achieving processes which are consistent with the usage rate (180%) as of before the fault occurred. Therefore, the reconfiguration determining section 103 determines not to perform the reconfiguration of hardware resources of the target partition. As described above, by allowing the reconfiguration determining section 103 to determine whether the reconfiguration of a target partition is to be performed, or not, on the basis of configuration information and performance information related to the target partition, for example, in the case where the target partition is capable of continuously performing processes which had been performed before the hardware resource experienced the fault, it is possible to make it unnecessary to perform reconfiguration of hardware resources of the target partition.

Moreover, in the case where alarm notification necessity/non-necessity information represents that it is needed to notify a notification indicating that a fault has occurred in a hardware resource included in one of the partitions 12, the reconfiguration determining section 103 notifies the system administrator's device 3 of the occurrence of a fault in the hardware resource.

The partition selecting section 104 selects a partition targeted for reconfiguration as a selected partition on the basis of priorities stored in the priority DB 106. More specifically, the partition selecting section 104 selects a partition 12 having the lowest priority as the selected partition. That is, upon occurrence of a fault in a hardware resource included in one of partitions 12, the partition selecting section 104 has a function as partition selecting means for selecting a partition to be selected on the basis of priorities stored in the priority DB 106. Further, the partition selecting section 104 acquires configuration information related to the selected partition by referring to the partition configuration information DB 36, and notifies the execution directing section 105 of information related to hardware resources included in the selected partition, which is represented by the acquired configuration information, and information related to the faulty hardware resource. The execution directing section 105 creates control information for directing replacement of the faulty hardware resource with a hardware resource included in the selected partition, and transmits this control information to the reconfiguration executing section 34. Upon receipt of the foregoing control information from the execution directing section 105, the reconfiguration executing section 34 replaces the faulty hardware resource with one of the hardware resources included in the selected partition in accordance with the control information, and thereby, performs reconfiguration of hardware resources of the target partition and the selected partition.

In the information processing apparatus according to this embodiment, as described above, the priority calculating section 101 calculates the sum total of point values representing degrees of importance with respect to pieces of software operating in each of the partitions 12 so that the calculated sum total of the point values represents a priority corresponding to the partition 12, and the partition selecting section 104 selects one of the partitions 12 having the lowest priority as a selected partition. Therefore, in the information processing apparatus according to this embodiment, it is possible to give a priority of being a target for reconfiguration to one of the partitions 12, for which the total sum of importance degrees with respect to pieces of software operating in the partition 12 is the lowest one among those of all of the partitions 12.

Furthermore, in the information processing apparatus according to this embodiment, as described above, the priority calculating section 101 calculates the sum total of point values with respect to pieces of software operating in each of the partitions 12 during either a time slot within a day, a day of the week, or a time slot within a day of the week when the fault has occurred in the hardware resource so that the calculated total sum of the point values represents a priority corresponding to the partition 12 in which the pieces of software are operating. Therefore, in the information processing apparatus according to this embodiment, it is possible to give a priority of being a target for reconfiguration to one of the partitions 12, for which the total sum of the degrees of importance with respect to pieces of software operating in the partition 12 during either a time slot within a day, a day of the week, or a time slot within a day of the week when the fault has occurred in the hardware resource is the lowest one among those of all of the partitions 12.

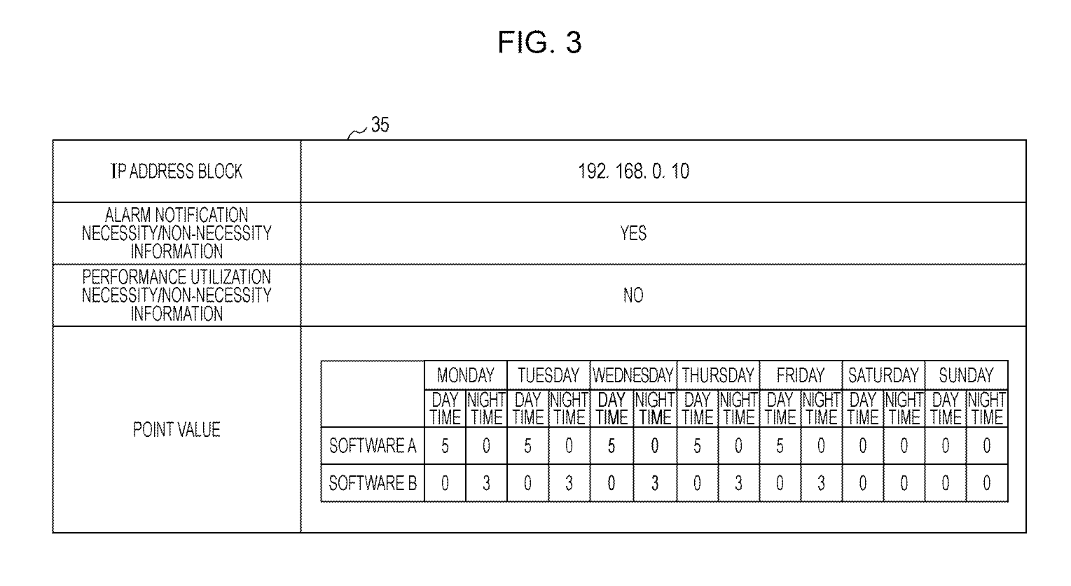

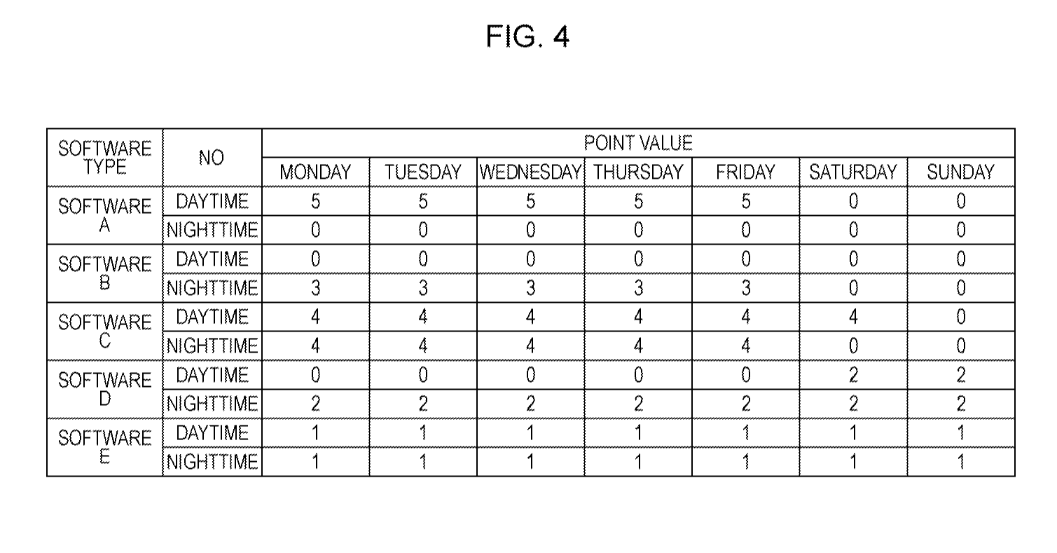

FIG. 3 is a diagram illustrating an example of a block of point setting information set in a point setting information DB. In the example depicted in FIG. 3, a block of point setting information includes an IP address block, alarm notification necessity/non-necessity information, performance utilization necessity/non-necessity information, and point values. In the IP address block, an IP address of the MMB 11 included in the server device 1 is set. In the alarm notification necessity/non-necessity information, for example, “yes” or “no” is set. “Yes” indicates that the system administrator's device 3 is to be notified of the occurrence of a fault in a hardware resource included in the relevant partition 12 as an alarm, and in contrast, “no” indicates that the system administrator's device 3 is not to be notified of the occurrence of a fault in a hardware resource included in the relevant partition 12 as an alarm. In the performance utilization information, for example, “yes” or “no” is set. “Yes” indicates that the necessity or non-necessity of reconfiguration of hardware resources of the relevant partition 12 performed by utilizing performance information is to be determined, and in contrast, “no” indicates that the necessity or non-necessity of reconfiguration of hardware resources of the relevant partition 12 performed by utilizing performance information is not to be determined. In the point values, point values indicating degrees of importance, which are allocated in advance to individual pieces of software operating in the relevant partition 12, are set. For example, in the point values, in accordance with allocation of point value related information depicted in FIG. 4, point values which are associated with each piece of software operating in the relevant partition 12 are set so as to respectively correspond to time slots within each day of the week. In the example depicted in FIG. 3, with respect to each piece of software operating in the relevant partition 12 (for example, software A and software B), the point values are set so as to respectively correspond to daytime and nighttime in each of weekdays, on Saturday, and on Sunday.

FIG. 4 is a diagram illustrating an example of allocation of point value related information, which is included in the point setting information, with respect to individual pieces of software operating in the relevant partition 12. In FIG. 4, for example, daytime represents a time slot within a day from six o'clock until eighteen o'clock, and a nighttime represents a time slot within a day from eighteen o'clock until six o'clock. The allocation of point value related information depicted in FIG. 4 represents point values, each of which corresponds to one time slot within each day of the week with respect to each of pieces of software operating in the partitions 12. By referring to FIG. 4, for example, it can be understood that point values corresponding to daytimes in weekdays with respect to a piece of software, which is termed software A, are five, respectively.

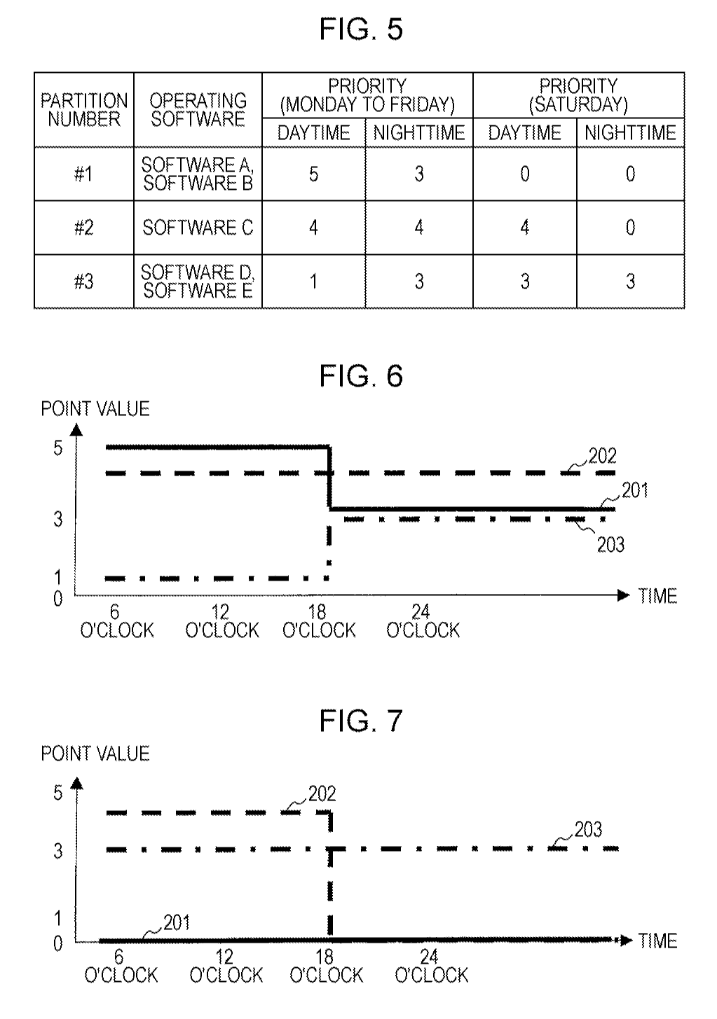

FIG. 5 is a diagram illustrating an example of priorities corresponding to respective partitions, which are calculated by a priority calculating section included in a configuration managing section. In FIG. 5, priorities associated with daytimes and nighttimes of weekdays (from Monday to Friday) and Saturday for respective partitions 12 are depicted. For example, it is assumed that pieces of software operating in a first partition 12 having a partition number #1 are software A and software B, a piece of software operating in a second partition 12 having a partition number #2 is software C, and pieces of software operating in a third partition 12 having a partition number #3 are software D and software E. The priority calculating section 101 calculates the total sums of point values corresponding to respective time slots within each day of the week with respect to pieces of software operating in each of the partitions 12, the point values being included in the point setting information, so that the calculated total sums of the point values represent priorities with respect to respective time slots within each day of the week, corresponding to each of the partitions 12. For example, by referring to allocation of point values related information with respect to pieces of software depicted in FIG. 4, it can be understood that a point value corresponding to daytime of each of the weekdays associated with the software A is five, further, a point value corresponding to daytime of each of the weekdays associated with the software B is zero, and thus, in a block of point setting information corresponding to the partition 12 having a partition number #1 in which the two pieces of software A and B are operating, a point value corresponding to daytime of each of the weekdays associated with the software A is set to five, and a point value corresponding to daytime of each of the weekdays associated with the software B is set to zero. Therefore, as depicted in FIG. 5, the priority calculating section 101 obtains a point value of five resulting from totaling of the foregoing point values five and zero as a priority corresponding to daytime of each of the weekdays associated with the partition 12 having the partition number #1 in which the pieces of software A and B are operating. In FIG. 6, time transitions of priorities for weekdays with respect to respective partitions depicted in FIG. 5 are illustrated. Further, in FIG. 7, time transitions of priorities for Saturday with respect to respective partitions depicted in FIG. 5 are illustrated. Reference numbers 201, 202 and 203 depicted in FIGS. 6 and 7 represent time transitions of priorities corresponding to partitions 12 having partition numbers #1, #2 and #3, respectively.

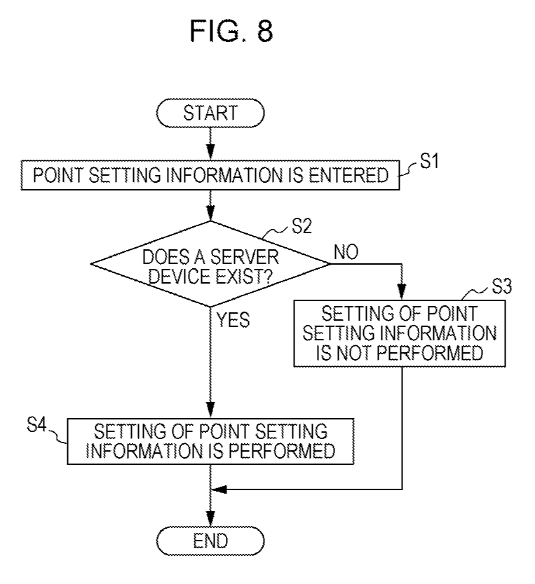

FIG. 8 is a diagram illustrating an example of a flow of the processes of setting point setting information in a setting information DB. Firstly, the system administrator's device 3 enters point setting information into the setting section 31 inside the MMB 11 of the server device 1 (step S1). Next, the setting section 31 determines whether the MMB 11 corresponding to an IP address included in the point setting information exists, or not, and further, on the basis of the determination result, determines whether the server device 1 exists, or not (step S2). In the case where the setting section 31 determines that the MMB 11 corresponding to the foregoing IP address exists, the setting section 31 determines that the server device 1 exists. In the case where the setting section 31 determines that the MMB 11 corresponding to the foregoing IP address does not exist, the setting section 31 determines that the server device 1 does not exist. In the case where the setting section 31 determines that the server device does not exist, the setting section 31 does not set the point setting information in the point setting information DB 35 (step S3). In the case where the setting section 31 determines that the server device exists, the setting section 31 sets the point setting information in the point setting information DB 35 (step S4).

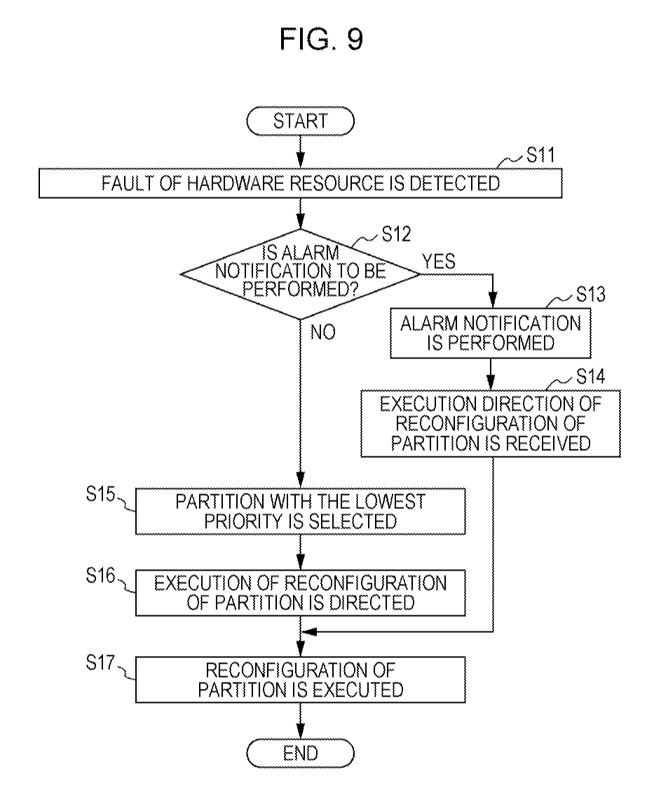

FIG. 9 is a diagram illustrating an example of a flow of the processes of performing control of reconfiguration of resources of an apparatus according to an embodiment of the present invention. Firstly, the fault detecting section 32 detects that a fault has occurred in a hardware resource inside one of the partitions 12 (step S11), and notifies the configuration managing section 33 of the detection result. Next, on the basis of alarm notification necessity or non-necessity information included in the point setting information inside the pointing setting information DB 35, the configuration managing section 33 determines whether an alarm notification to the system administrator's device 3 is to be performed, or not (step S1). In the case where the configuration managing section 33 determines that the alarm notification to the system administrator's device 3 is to be performed, the configuration managing section 33 performs the alarm notification to the system administrator's device 3 (step S13). During step S13, the configuration managing section 33 notifies the system administrator's device 3 of, for example, information related to a hardware resource experiencing the fault, a priority for each of the partitions 12, and plans for reconfiguration of hardware resources of partitions, and the like. The foregoing plans for reconfiguration of hardware resources of partitions include, for example, a plan in which the hardware resource experiencing the fault is to be replaced with a hardware resource inside one of the partitions which has the lowest priority.

Furthermore, the reconfiguration executing section 34 receives an executing direction for reconfiguration of hardware resources of the partitions 12 from the system administrator's device 3 (step S14), and the flow proceeds to step S17. In the case where the configuration managing section 33 determines that the alarm notification to the system administrator's device 3 is not to be performed, the configuration managing section 33 selects one of the partitions 12 having the lowest priority from among those stored in the priority DB 106 as a selected partition (step S15). Subsequently, the configuration managing section 33 directs the reconfiguration executing section 34 to execute reconfiguration of hardware resources of the partitions 12 (step S16). For example, the configuration managing section 33 transmits control information for directing a replacement of the hardware resource experiencing the fault with a hardware resource included in the selected partition to the reconfiguration executing section 34. Further, the reconfiguration executing section 34 executes reconfiguration of hardware resources of the partitions 12 (step S17).

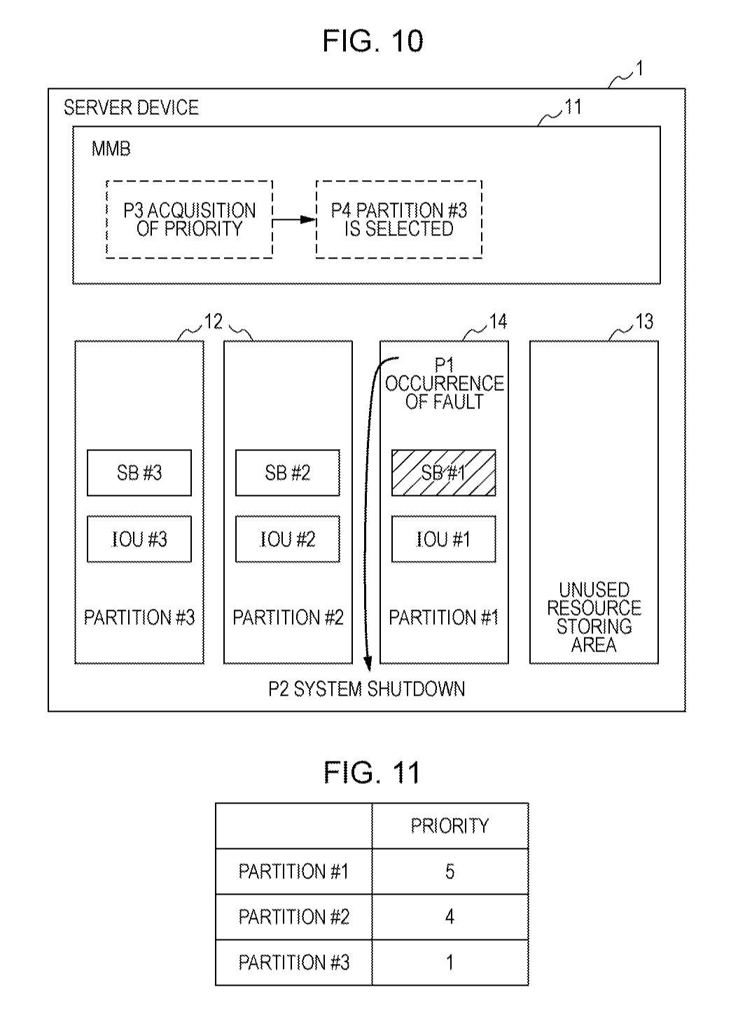

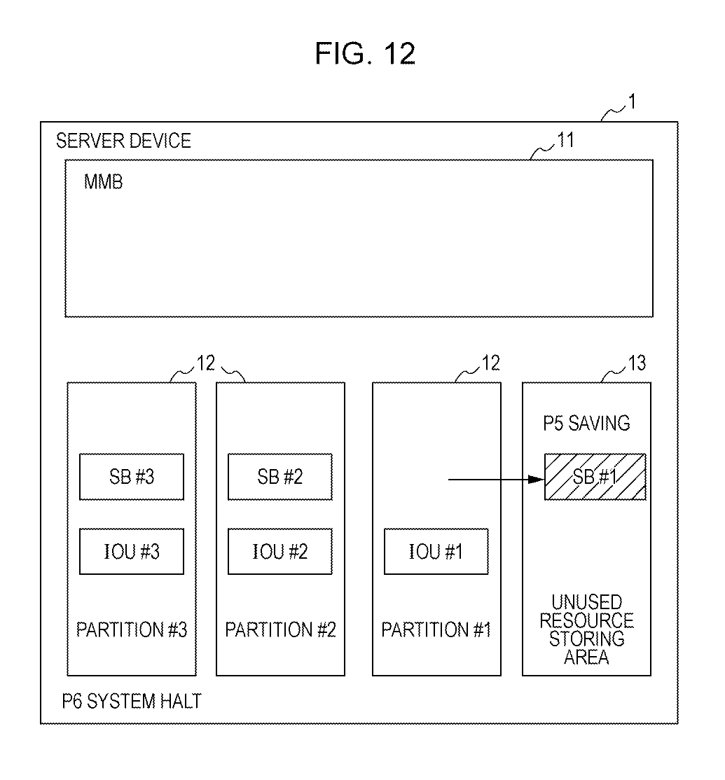

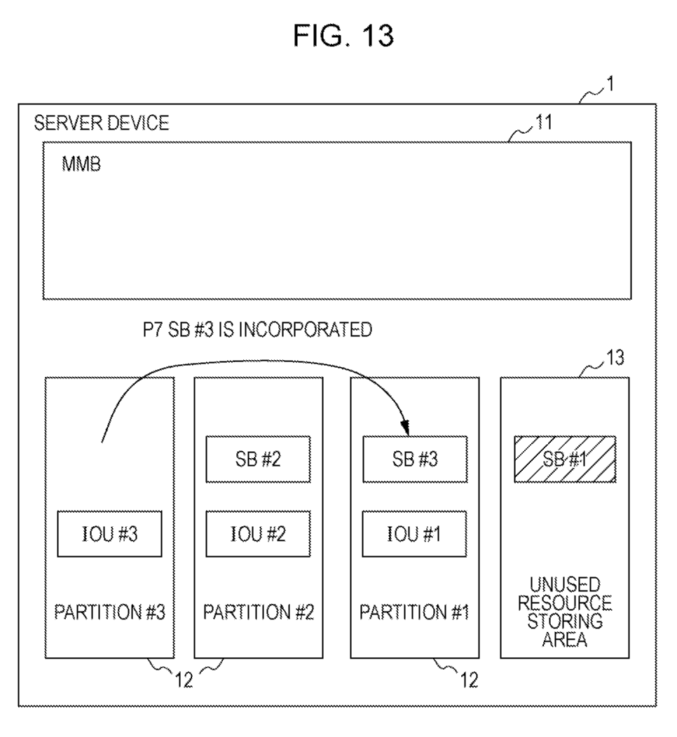

A first example of the processes of performing control of reconfiguration of resources of an apparatus according to an embodiment of the present invention will be hereinafter described with reference to FIGS. 10 to 13. In this example, the server device 1 includes three partitions 12 including of partitions #1, #2 and #3. Further, the partitions #1, #2 and #3 include an SB #1 and an IOU #1, an SB #2 and an IOU #2, and an SB #3 and an IOU #3, respectively. Furthermore, each of the SBs include memory, and each of the IOUs include HDDs. As depicted by P1 in FIG. 10, once a fault occurs in the SB #1 denoted by a shaded area inside the partition #1 at, for example, three P.M. on Wednesday, a system including the partition #1 is shut down (refer to P2 depicted in FIG. 10). Next, the configuration managing section 33 included in the MMB 11 of the server device 1 acquires priorities of individual partitions 12 from the priority DB 106 as of when the fault occurred (refer to P3 depicted in FIG. 10). For example, the foregoing information related to priorities of partitions 12 acquired above is depicted in FIG. 11. By referring to FIG. 11, it can be understood that one of the partitions 12 having the lowest priority is the partition #3. Therefore, the configuration managing section 33 selects the partition #3 as a selected partition (refer to P4 depicted in FIG. 10), and directs the reconfiguration executing section 34 to perform reconfiguration of hardware resources of the partitions 12 by replacing the SB #1 in the partition #1 with the SB #3 in the partition #3. Subsequently, the reconfiguration executing section 34 performs saving of the SB #1 in the partition #1 to the unused resource storing area 13 (refer to P5 depicted in FIG. 12). Further, the reconfiguration executing section 34 halts a system including the partition #3 (refer to P6 depicted in FIG. 12). Subsequently, the reconfiguration executing section 34 incorporates the SB #3 included in the partition #3 into the system including the partition #1 (refer to P7 depicted in FIG. 13). Further, the reconfiguration executing section 34 starts up respective systems including the partitions #1 and #3.

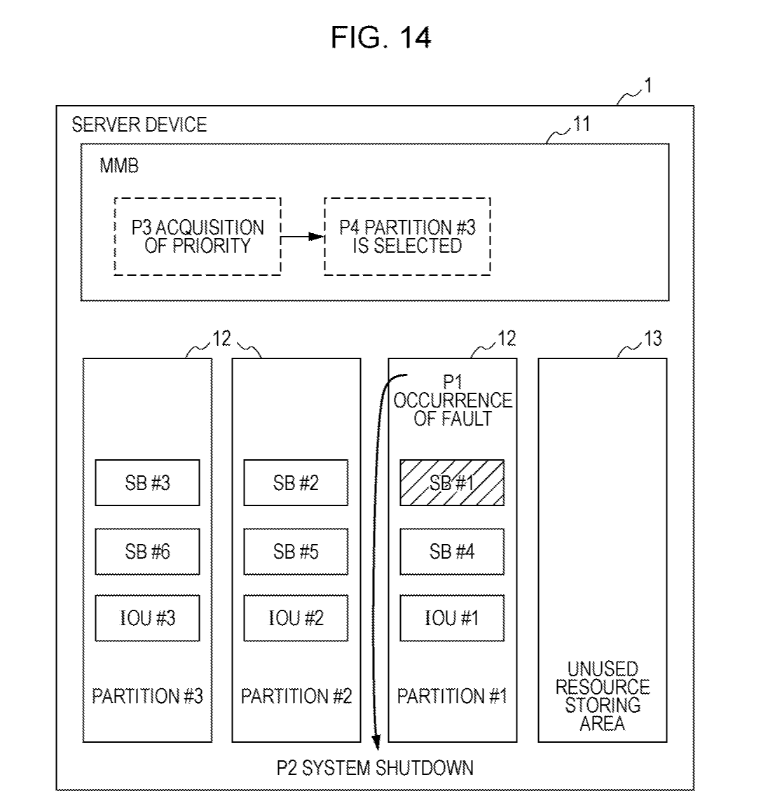

A second example of the processes of performing control of reconfiguration of resources of an apparatus according to an embodiment of the present invention will be hereinafter described with reference to FIGS. 14 to 17. As depicted in FIG. 14, in this example, a partition #1 includes an SB #1, an SB #4 and an IOU #1. A partition #2 includes an SB #2, an SB #5 and an IOU #2. A partition #3 includes an SB #3, an SB #6 and an IOU #3. Moreover, in this example, it is assumed that “yes” is set as performance utilization necessity/non-necessity information included in the point setting information inside the point setting information DB 35.

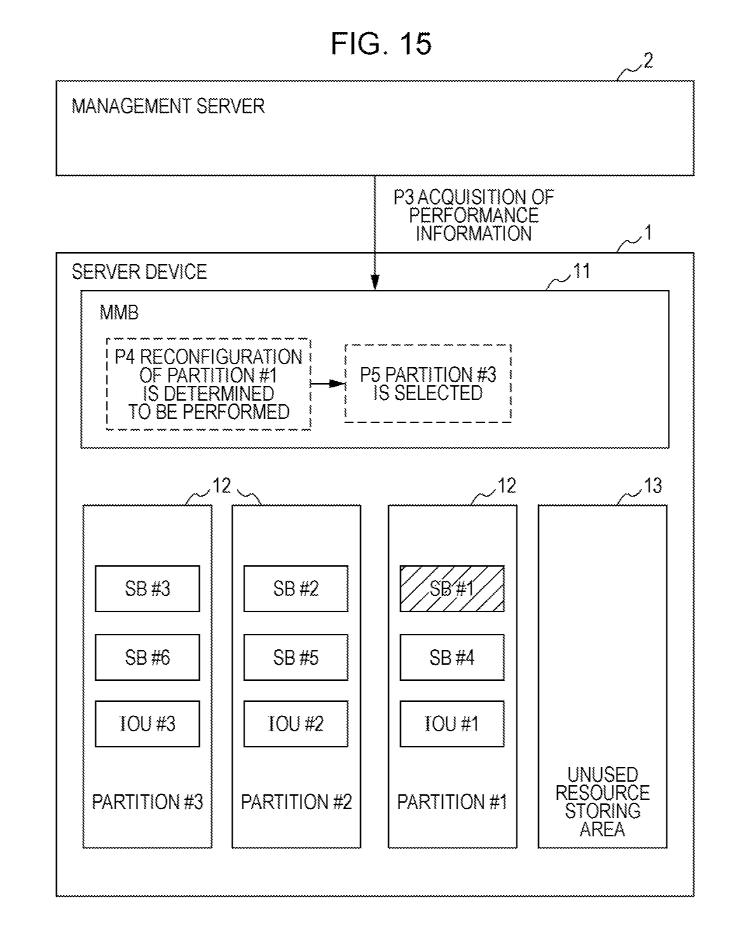

As depicted at P1 in FIG. 14, when a fault occurs in the SB #1 denoted by a shaded area inside the partition #1 at three P.M. on Wednesday, a system including the partition #1 is shut down (refer to P2 depicted in FIG. 14). Next, the configuration managing section 33 included in the MMB 11 acquires performance information related to the partition #1 from the performance managing section 21 included in the management server 2 (refer to P3 depicted in FIG. 15). The foregoing acquired performance information is, for example, a total sum of usage rates associated with CPUs included in the SB #1 and the SB #4 before the occurrence of the fault in the SB #1.

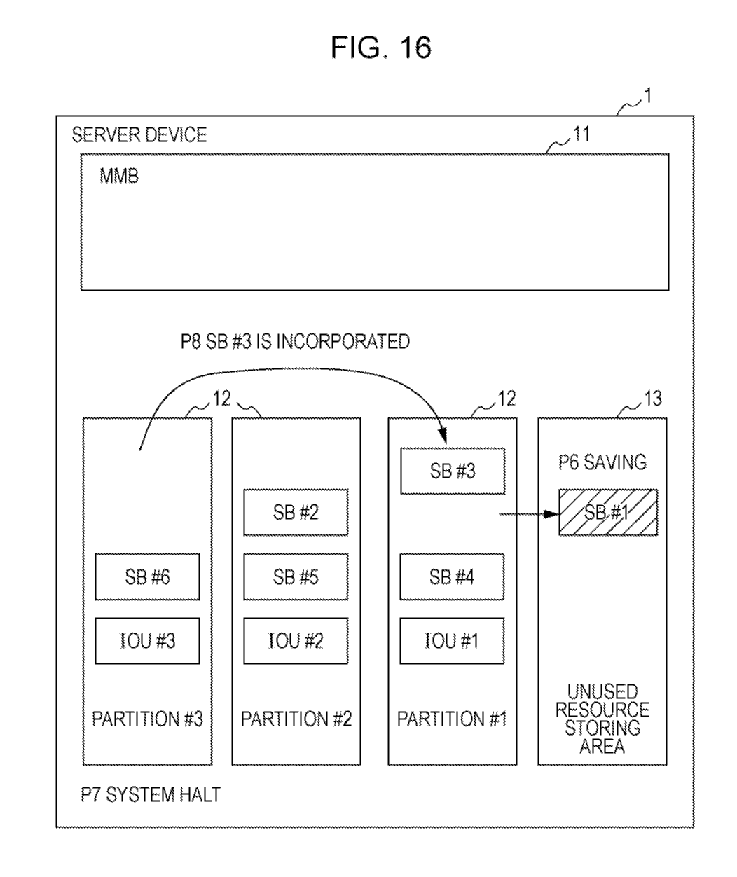

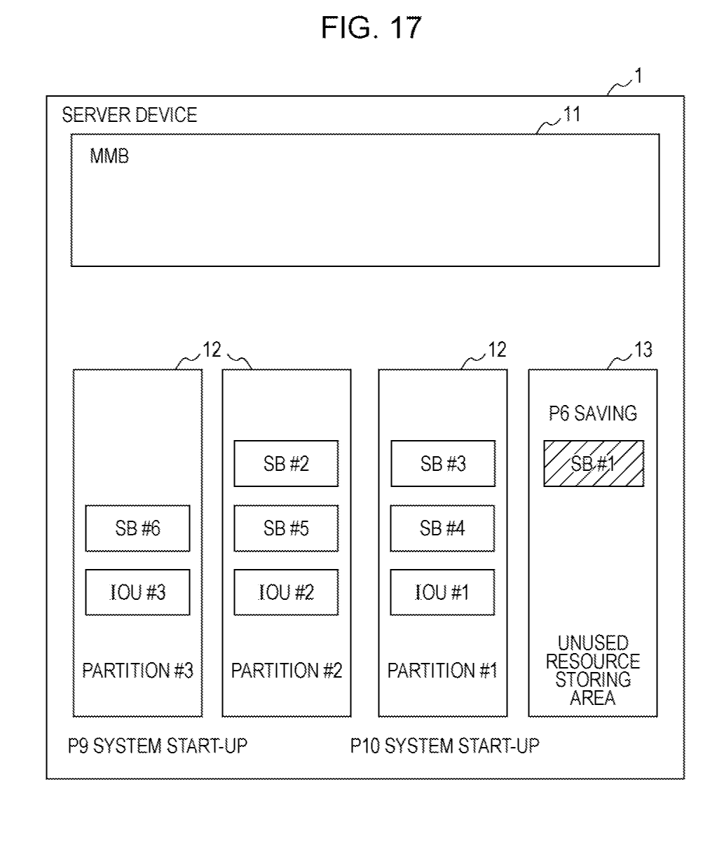

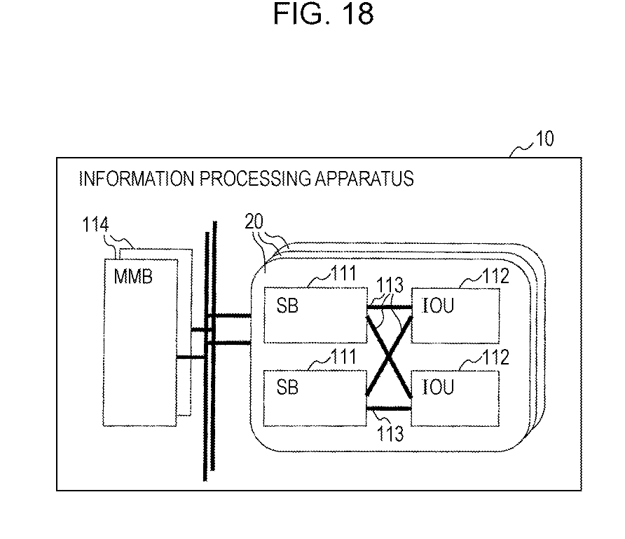

Subsequently, the configuration managing section 33 determines whether reconfiguration of hardware resources of the partition #1 is to be performed, or not, on the basis of the acquired performance information and configuration information associated with the partition #1 acquired from the partition configuration information DB 36. More specifically, the configuration managing section 33 determines whether the reconfiguration of hardware resources of the partition #1 is to be performed, or not, by making a determination as to whether processes consistent with a total sum of usage rates associated with CPUs included in the SB #1 and the SB #4, which have been acquired as the foregoing performance information, can be executed by the SB #4 not experiencing a fault, or not. For example, in the case where the foregoing total sum of CPU usage rates is more than 100%, the SB #4 is not capable of executing a process consistent with a usage rate of more than 100% associated with a CPU, and thus, the configuration managing section 33 determines that the reconfiguration of hardware resources of the partition #1 is to be performed. Further, for example, in the case where the foregoing total sum of usage rates associated with the CPUs is less than or equal to 100%, the SB 34 is capable of executing processes consistent with a usage rate of less than or equal to 100% associated with a CPU, and thus, the configuration managing section 33 determines that the reconfiguration of hardware resources of the partition #1 is not to be performed. In this example, it is assumed that the configuration managing section 33 determines that the reconfiguration of hardware resources of the partition #1 is to be performed (refer to P4 depicted in FIG. 15). Therefore, the configuration managing section 33 selects, for example, the partition #3 having the lowest priority as a selected partition by referring to the priorities inside the priority DB 106, and directs the reconfiguration executing section 34 to perform reconfiguration of hardware resources of the partitions 12 by replacing the SB #1 included in the partition #1 with, for example, the SB #3 included in the partition #3. Subsequently, the reconfiguration executing section 34 performs saving of the SB #1 included in the partition #1 into the unused resource storing section 13 in accordance with the foregoing direction from the configuration managing section 33 (refer to P6 depicted in FIG. 16) Further, the reconfiguration executing section 34 halts a system including the partition #3 (refer to P7 depicted in FIG. 16). Subsequently, the reconfiguration executing section 34 incorporates the SB #3 included in the partition #3 into a system including the partition #1 (refer to P8 depicted in FIG. 16). Furthermore, the reconfiguration executing section 34 starts up the systems including the partition #1 and the partition #3, and proceeds with information processes which had been performed by the partitions 12, respectively (refer to P9 and P10 depicted in FIG. 17).

All examples and conditional language recited herein are intended for pedagogical purposes to aid the reader in understanding the invention and the concepts contributed by the inventor to furthering the art, and are to be construed as being without limitation to such specifically recited examples and condition, nor does the organization of such examples in the specification relate to a depicting of superiority and inferiority of the invention. Although the embodiment of the present inventions have been described in detail, it should be understood that the various changes, substitutions, and alternations could be made hereto without departing from the spirit and scope of the invention.

What is claimed is:

1. An information processing apparatus for providing a plurality of services by a plurality of software programs, the information processing apparatus comprising:
a plurality of hardware resources;
a storage unit that stores priorities of the services; and
a processor that controls configuration of the hardware resources in accordance with a process including:
partitioning the plurality of hardware resources into a plurality of groups each of which executes each of the software programs,
determining, upon detecting a failure in at least one of the hardware resources in at least one of the groups, another hardware resource which belongs to another group for executing another software programs on the basis of the priorities of services provided by the software programs in reference to the storage unit, and
assigning the another hardware resource to the group which includes the one of the hardware resources having the failure so as to renew configuration of the hardware resources.

2. The information processing apparatus according to claim 1, wherein the processor generates a priority information indicative of order of each software programs priority on the basis of priorities of the priorities of the services, and determines, upon detecting a failure in at least one of the hardware resources in at least one of the groups, another hardware resource which belongs to another group for executing another software programs on the basis of the priority information.

3. The information processing apparatus according to claim 2, wherein the processor determines a hardware resource which has the lowest priority in the priority information.

4. The information processing apparatus according to claim 3, wherein the priority information is a sum total of point values representing degrees of importance with respect to the services.

5. The information processing apparatus according to claim 3, wherein the point values are assigned so as to respectively correspond to time slots within each day of the week, the point values representing degrees of importance with respect to the services, and the processor calculates the sum total of point values with respect to the services during either a time slot within a day, a day of the week, or a time slot within a day of the week when the failure has occurred in the hardware resource.

6. The information processing apparatus according to claim 1, further comprising a management device for managing performance information related to hardware resources;
wherein the processor determines, upon detecting a failure in at least one of the hardware resources in at least one of the groups, whether to assign the another hardware resource to the group which includes the one of the hardware resources having the failure so as to renew configuration of the hardware resources on the basis of the performance information managed by the management device, and selects the another hardware resource on the basis of the priorities of the services upon determining to assign the another hardware resource.

7. A configuration control method for providing a plurality of services by a plurality of software programs, the configuration control method comprising:
partitioning a plurality of hardware resources into a plurality of groups each of which executes each of the software programs;
determining, upon detecting a failure in at least one of the hardware resources in at least one of the groups, another hardware resource which belongs to another group for executing another software programs on the basis of priorities of services provided by the software programs in reference to the storage unit; and
assigning the another hardware resource to the group which includes the one of the hardware resources having the failure so as to renew configuration of the hardware resources.

8. The configuration control method according to claim 7, further comprising:
generating a priority information indicative of order of each software programs priority on the basis of priorities of the priorities of the services; and
determining, upon detecting a failure in at least one of the hardware resources in at least one of the groups, another hardware resource which belongs to another group for executing another software programs on the basis of the priority information.

9. The configuration control method according to claim 8, wherein a hardware resource which has the lowest priority in the priority information is determined as the another hardware resource.

10. The configuration control method according to claim 9, wherein the priority information is a sum total of point values representing degrees of importance with respect to the services.

11. The configuration control method according to claim 9, wherein the point values are assigned so as to respectively correspond to time slots within each day of the week, the point values representing degrees of importance with respect to the services, and the sum total of point values with respect to the services during either a time slot within a day, a day of the week, or a time slot within a day of the week when the failure has occurred in the hardware resource is calculated.

12. The configuration control method according to claim 7, further comprising managing performance information related to hardware resources;
wherein upon detecting a failure in at least one of the hardware resources in at least one of the groups, it is determined that whether to assign the another hardware resource to the group which includes the one of the hardware resources having the failure so as to renew configuration of the hardware resources on the basis of the performance information managed by the management device, and selects the another hardware resource on the basis of the priorities of the services upon determining to assign the another hardware resource.
